(19) United States
(12) Patent Application Publication
(10) Pub. No.: US 2010/0069045 A1
(43) Pub. Date: Mar. 18, 2010

(54) MOBILE COMMUNICATION TERMINAL WITH ENHANCED PHONEBOOK MANAGEMENT

(75) Inventors: Raphael Grignani, Santa Monica, CA (US); Mike Kruzeniski, Santa Monica, CA (US)

Correspondence Address: Perman & Green, LLP, 99 Hawley Lane, Stratford, CT, 06614, US

(73) Assignee: NOKIA CORPORATION, Espoo (FI)

(21) Appl. No.: 12/300,254

(22) PCT Filed: May 23, 2006
(86) PCT No.: PCT/EP06/04877

§ 371 Date: Jun. 15, 2009

(51) Int. Cl. G06F 3/048; H04M 3/42; G06F 15/16

(52) U.S. Cl. 455/414.1; 709/203; 715/810; 715/764

(57) ABSTRACT

A mobile communication terminal having a phonebook and a method of managing phonebook entries having a processor and a memory having at least one phonebook entry and at least one metadata entry stored therein. The method allows the user to sort the phonebook entries in accordance with the metadata associated with the therewith. The phonebook entries can be shown/listed in a sorted order. The terminal may update the metadata via the mobile network. The metadata may include time zone information and the terminal may show time zone information together with content detail information on a display of the terminal.

### CROSS REFERENCE TO RELATED APPLICATIONS

This application is the National Stage of International Application No. PCT/EP2006/004877 International Filing Date, 23 May 2006, which designated the United States of America, and which International Application was published under PCT Article 21 (2) as WO Publication No. WO2007/134623, the disclosure of which is incorporated herein by reference in its entirety.

### BACKGROUND

1. Field

The disclosed embodiments relate to management of phonebook entries in a mobile communication terminal, in particular to management of a large number of phonebook entries.

2. Brief Description of Related Developments

The Nokia 6230i user guide discloses a mobile communication terminal with a phonebook function for storing the phone number(s) and/or contact information of plurality of “contacts”. The contacts can be arranged into groups and a dedicated ringing tone can be associated with a group.

The number of entries (contacts) that users make in a phonebook of a mobile communication is ever increasing. The number of applications that use the contact data in the phonebook is also increasing and includes for example short messaging applications, e-mail applications, VoIP applications, and instant messaging applications. Further, the increasing globalization causes these entries to be more geographically dispersed than in the past. Increased international travel activity further increases the complexity of keeping tack of contacts.

This increased complexity, has created a need to improve the handling of phonebook entries in mobile communication terminals.

### SUMMARY

On this background, the aspects of the disclosed embodiments provide a mobile communication terminal with enhanced phonebook management. This aspect is achieved by providing a mobile communication terminal with a phonebook function, comprising a processor controlling the operation of the terminal, a memory coupled to the processor, the memory having at least one phonebook data entry and metadata associated with the phonebook data entry, wherein the processor is configured to sort phonebook entries by a metadata related criterion.

By providing a sorting criterion that is related to metadata associated with the phonebook entries, users are given a greater degree of control over the information in the phonebook. Thus, the phonebook is easier to use and the technology will be more readily accepted by a broad public, even if the phonebook contains many entries.

Preferably, the processor is configured to show the phonebook data entries on the display sorted by the metadata related criterion.

The criterion can be based on a country code and/or area code in the phone number in the phonebook entry data.

Preferably, the terminal is suitable for operation in a cellular network, in which case the metadata may include data on the current cell in which a terminal associated with a phonebook data entry is logged onto and the sorting criterion is based on the current cell data. Thus, the phonebook can be kept updated with the correct metadata even if the mobile terminal associated with the phonebook entry is not located in its home position.

Preferably, the terminal is suitable for operation in a cellular network, in which case the processor can be configured to receive location information concerning other terminals that are associated with one of the phonebook data entries via the network. Thus, the phonebook can be kept updated with the correct metadata even if the mobile terminal associated with the phonebook entry is not located in its home position. The location information may comprise time zone information, town information, and/or country information.

The processor in the terminal may be configured to add or update metadata to the memory by means of data received via a network to which the mobile communication terminal is connected.

The processor on the terminal may be configured to show the sorted phonebook data entries on the display as a, preferably, scrollable list, as an array or on a geographical map.

The processor on the terminal may be configured to extract metadata from the phonebook data entries.

Preferably, the sorting criterion is related to dynamic metadata, such as a time zone associated with a phonebook entry.

In another aspect, the disclosed embodiments provide a mobile communication terminal with an improved phonebook function. One embodiment provides a mobile communication terminal with a phonebook function, comprising a processor controlling the operation of the terminal, a display coupled to the processor, a memory coupled to the processor, the memory having at least one phonebook data entry and time zone information associated with the phonebook data entry, wherein the processor is configured to show the phonebook data entry on the display together with information about the time zone information associated with the phonebook entry.

Thus, a user is immediately aware of the local time of a contact with whom a new communication is to be established. In this way the user of the mobile communication terminal has the information required to decide if it is a good time or not for initiating a new communication with a particular contact.

Preferably, the processor in the mobile communication is configured to show a plurality of phonebook entries as a list or array with the time zone information adjacent the phonebook entry concerned. The time zone information can be shown as a local clock.

In another aspect the disclosed embodiments provide an enhanced method for handling phonebook entries in a phonebook on a mobile communication terminal. One embodiment provides a method for handling phonebook entries in a phonebook on a mobile communication terminal comprising storing a plurality of phonebook entries in the phonebook, assigning metadata to the phonebook entries, and sorting the phonebook entries by a criterion related to the metadata.

Preferably, the method further comprises extracting metadata from the phonebook entries stored in the phone.

The method may also comprise showing the phonebook data entries on a display of the terminal sorted by the metadata related criterion.

Preferably, the method further comprises receiving dynamic metadata concerning other terminals that are associated with one of the phonebook data entries via the network.

The method may also comprise adding or updating metadata to the terminal by means of data received via a network to which the mobile communication terminal is connected.

In yet another aspect, the disclosed embodiments provide a software product for executing the methods described above on a processor of a mobile communication terminal.

A further aspect of the disclosed embodiments provides a software product for use in a mobile communication terminal that is provided with a phonebook, the software product comprising software code for storing phonebook entries in the phonebook, software code to assigning metadata to the phonebook entries, and software code to sort the phonebook entries by a criterion related to the metadata.

The software product may further comprise software code for extracting metadata from the phonebook entries stored in the phone.

The software product preferably comprises software code for showing the phonebook data entries on a display of the terminal sorted by the metadata related criterion.

The software product may also comprise software code for handling dynamic metadata concerning other terminals that are associated with one of the phonebook data entries that are received by the terminal from a network.

Another aspect of the disclosed embodiments provides a method for handling phonebook entries in a phonebook on a mobile communication terminal comprising storing phonebook entries in a memory of the terminal, associating time zone data with the phonebook entries, and showing phonebook entries on a display of the terminal together with information about the time zone associated with the phonebook entries.

A further aspect of the disclosed embodiments provide a software product for use in a mobile communication terminal that is provided with a phonebook, the software product comprising software code for storing phonebook entries in a memory of the terminal, and software code for associating time zone data with the phonebook entries, software code for showing phonebook entries on a display of the terminal together with information about the time zone associated with the phonebook entries.

Further aspects, features, advantages and properties of the mobile communication terminals, methods and software products according to the disclosed embodiments will become apparent from the detailed description.

### BRIEF DESCRIPTION OF THE DRAWINGS

In the following detailed portion of the present description, the disclosed embodiments will be explained in more detail with reference to the exemplary embodiments shown in the drawings, in which:

FIG. 1 is a front view of a mobile communication terminal according to an embodiment,

FIG. 2 is a block diagram illustrating the general architecture of a mobile communication terminal of FIG. 1, and

FIGS. 3 to 5 are screenshots of the mobile communication terminal of FIG. 1 illustrating the operation of a phonebook.

### DETAILED DESCRIPTION OF THE DRAWINGS

In the following detailed description, the device and the method according to the disclosed embodiments in the form of a personal computer, PDA, mobile terminal or a mobile communication terminal in the form of a cellular/mobile phone will be described by the preferred embodiments.

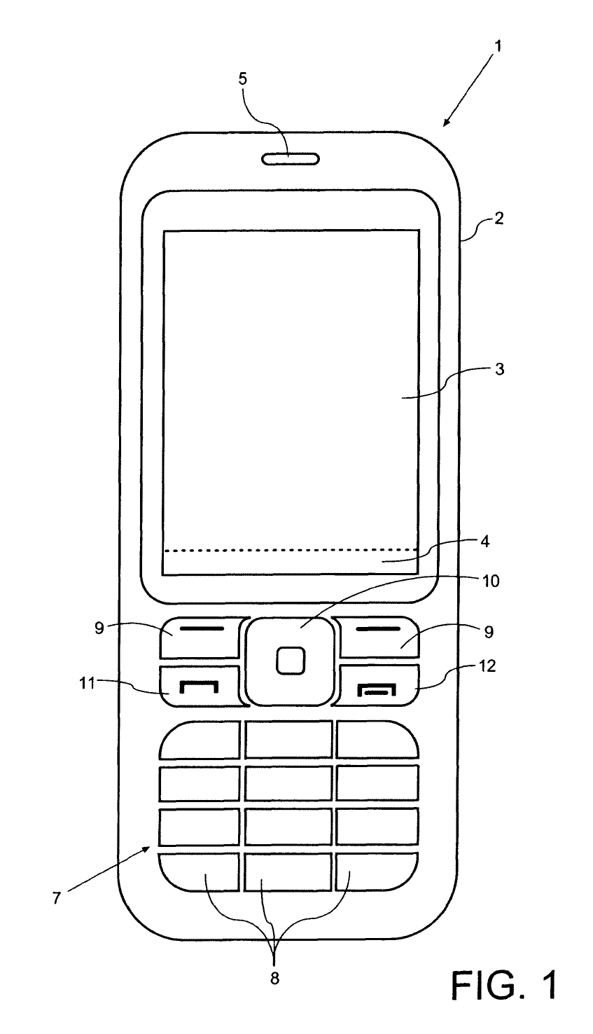

FIG. 1 illustrates a first embodiment of a mobile terminal in the form of a mobile telephone by a front view. The mobile phone 1 comprises a user interface having a housing 2, a display 3, an on/off button (not shown), a speaker 5 (only the opening is shown), and a microphone 6 (not visible in FIG. 1). The phone 1 according to the first preferred embodiment is adapted for communication via a cellular network, such as the GSM 900/1800 MHz network, but could just as well be adapted for use with a Code Division Multiple Access (CDMA) network, a 3G network, or a TCP/IP-based network to cover a possible VoIP-network (e.g. via WLAN, WIMAX or similar) or a mix of VoIP and Cellular such as UMA (Universal Mobile Access).

The keypad 7 has a first group of keys 8 as alphanumeric keys, by means of which the user can enter a telephone number, write a text message (SMS), write a name (associated with the phone number), etc. Each of the twelve alphanumeric keys 8 is provided with a figure “0-9” or a sign “#” or “*”, respectively. In alpha mode each key is associated with a number of letters and special signs used in the text editing.

The keypad 2 has additionally a second group of keys comprising two softkeys 9, two call handling keys (offhook key and onhook key 12), and a 5-way navigation key 10 (up, down, left, right and center: select/activate). The function of the softkeys 9 depends on the state of the phone, and navigation in the menu is performed by using the navigation-key 10. The present function of the softkeys 9 is shown in separate fields (soft labels) in a dedicated area 4 of the display 3, just above the softkeys 9. The two call handling keys 11,12 are used for establishing a call or a conference call, terminating a call or rejecting an incoming call. This key layout is characteristic for e.g. the Nokia 6230i™ phone.

The navigation key 10 is a four- or five-way key which can be used for cursor movement, scrolling and selecting (five-way key) and is placed centrally on the front surface of the phone between the display 3 and the group of alphanumeric keys 7.

A releasable rear cover (not shown) gives access to the SIM card (not shown), and the battery pack (not shown) in the back of the phone that supplies electrical power for the electronic components of the mobile phone 1.

The mobile phone 1 has a flat display 3 that is typically made of an LCD with optional back lighting, such as a TFT matrix capable of displaying color images. A touch screen may be used instead of a conventional LCD display.

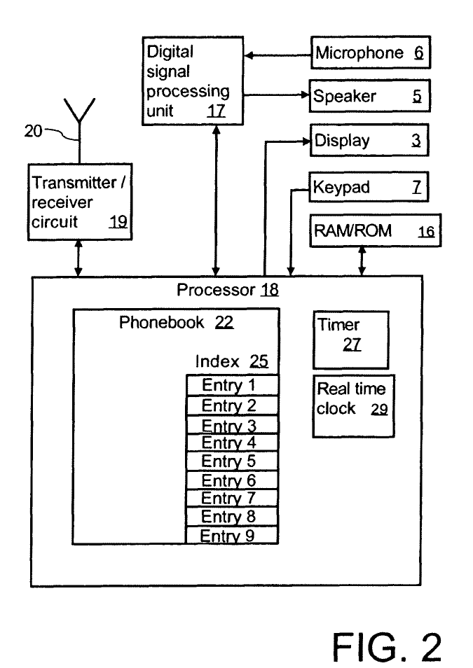

FIG. 2 illustrates in block diagram form the general architecture of a mobile phone 1 constructed in accordance with the disclosed embodiments. A processor 18 controls the communication with the cellular network via the transmitter/receiver circuit 19 and an internal antenna 20. A microphone 6 transforms the user's speech into analogue signals, the analogue signals formed thereby are A/D converted in an A/D converter (not shown) before the speech is encoded in a digital signal processing unit 17 (DSP). The encoded speech signal is transferred to the processor 18, which e.g. supports the GSM terminal software. The processor 18 also forms the interface to the peripheral units of the apparatus, including a RAM memory and a Flash ROM memory 16, the graphical display 3, and keypad 2 (as well as data, power supply, etc.). The digital signal-processing unit 17 speech-decodes the signal, which is transferred from the processor 18 to the speaker 5 via a D/A converter (not shown). Typically, the processor 18 will contain the DSP 17 and the RAM memory whilst the ROM memory is external in relation to the processor.

Memory 16 includes a plurality of stored constants and variables that are used by processor 18 during the operation of the mobile terminal 1. For example, memory 16 stores the values of the various feature parameters and an electronic phonebook 22. Typically, the phone book data is stored in the ROM so that the data are not lost when the terminal 1 is switched off. An operating program for controlling the operation of processor 18 is also stored in memory 16 (typically in the read only memory). Memory 16 is also used to store data provided by the user through the user interface. Furthermore, memory 16 is used to hold the sub-programs or sub-processes for controlling the operation of mobile terminal 1 and carrying out the embodiment. The entries in the phonebook (phonebook data entries, also referred to as “contacts” in this document) and metadata associated with these entries are stored in memory 16. The preferred embodiment operates ideally operates with dynamic metadata, such a time zone, geographical position, people/devices in the vicinity, weather, movement/speed etc. However, in particular if dynamic metadata is not available fixed metadata such as the country code in phone number, nationality, carrier, phone model, residing country/town etc. is used to fall back upon.

The phonebook entries may include regular contact data, such as name, street address, phone number, e-mail address, etc. Metadata may comprise time zone, country code, area code, town, country, geographical location, etc. or may be extracted from the phonebook entry data.

The operating program in memory 16 includes routines for sorting phonebook entries that are stored in an index 25 in the electronic phonebook 22 by a search criterion related to metadata associated with the phonebook entries. The mobile terminal 1 also comprises timer 27 (also referred to as a clock chip) coupled to processor 18 for synchronizing the operations of processor 18, and tracking time. A real time clock based on the input from time 27 provides time information for the user interface and for the phonebook 22.

The phonebook entries and the metadata associated therewith can be entered by a user via the user interface or can be received via the mobile phone network, other (non-mobile) network or can be downloaded from a computer to which the mobile terminal is connected, such as when connecting the mobile terminal with a USB cable or via Bluetooth to a personal computer. The terminal can be configured to automatically receive updated metadata from a server connected to the mobile phone network or a peer to peer network. This could be a presence server, a VoIP server, an instant messaging server or another server that contains a database with updated information about metadata of mobile subscribers or the like.

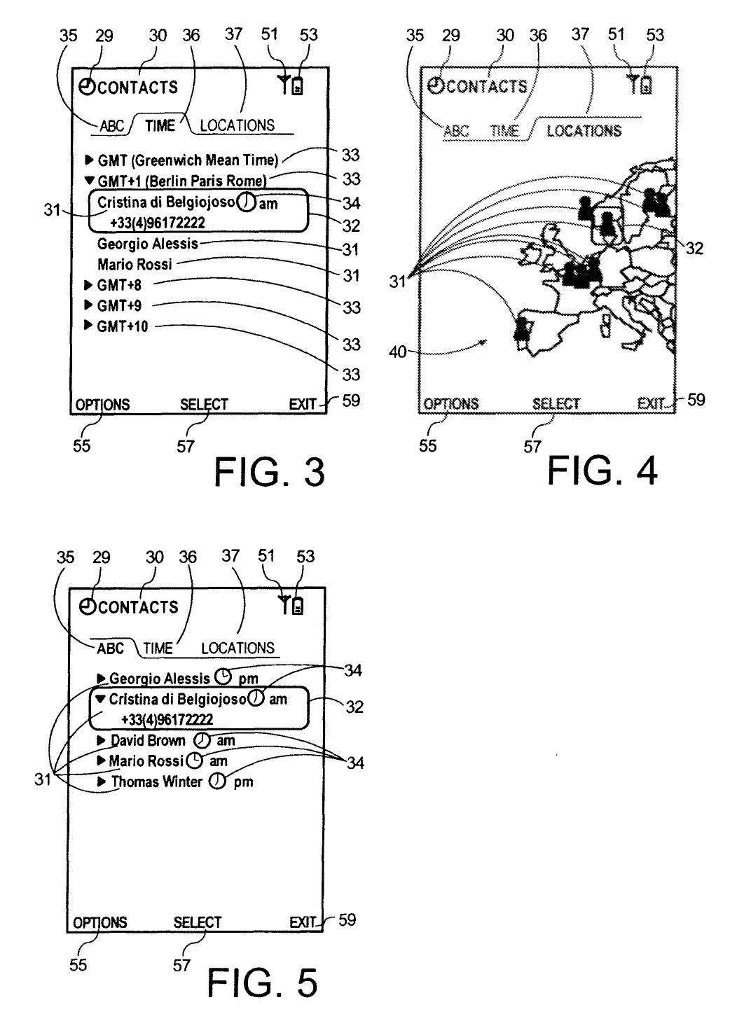

FIG. 3 shows a screenshot with the phonebook application 22 active. The phonebook application may be accessed via the menu or via various shortcuts.

When the phonebook application 22 is active the display 3 shows real time clock 29 in the upper left corner of the display 3. The real time clock 29 is preferably automatically updated in accordance with the time zone in which the mobile communication terminal 1 is presently residing. A label 30 adjacent the clock 29 indicates the present application being displayed (active window). In the right upper corner an antenna strength signal indicator 51 and battery level indicator 53 are shown. Three labels 55, 57 and for illustrating the function of the left softkey 9, navigation key 10 and the right to softkey 9 are shown in the bottom of the display 3.

The phonebook application 22 has three different modes for listing/showing the contacts (phonebook data entries) 31 that are stored in the memory 16. The three modes are indicated by tabs 35,36,37. The user can select the desired tab by using the navigation key 10.

In FIG. 3 the tab 36 “TIME” has been selected and the corresponding mode of the phonebook application 22 is active. This indicates to the phonebook application 22 that the contacts 31 are to be sorted by time zones 33 and displayed accordingly. The list (scrollable if longer than the display) shown on the display includes time zones 33 in consecutive order according to the internationally accepted Greenwich Mean Time (GMT) system.

One of the time zones 33 in the list is active (indicated by a downwardly pointing triangle on the left of the time zone concerned) and shows each of the contacts 31 that fall within this time zone 33. Within the active time zones 33 one of the contacts is active (indicated by a box 32 around the contact concerned). For the active contact 31 an increased amount of contact detail is shown, such as for example the phone number and the local time at the location associated with the contact. The local time is shown by a clock 34.

The user can switch between the active contact and active times by using the navigation key 10. With the left softkey 9 labeled “OPTIONS” the user can access various contact related functions, such as creating a new contact, edit an existing contact, deleting a contact, changing contact settings, etc. By centrally pressing the navigation key 10 labeled “SELECT” the user will be offered a number of possibilities to initiate communication with the selected contact, such as placing a phone call, sending an SMS message or sending an e-mail, etc. With the right softkey 9 labeled “Exit” the user can close the phonebook application and to go back to the menu or the idle mode.

The metadata used by the phonebook application when listing the contacts 31 in the time zone mode is preferably based on regularly updated time zone information associated with the contacts concerned. Thus, if the contact concerned is a mobile communication terminal that is presently not located in its home location, the time zone indication 33 could be based on information on the network cell in which the mobile communication terminal associated with the contact is logged onto. This information could be received directly from the mobile communication terminal associated with the contact concerned or via a server connected to the mobile network. If no updated location/time zone information is available, the country code and/or area code associated with the contact concerned can be used to derive the required metadata for determining an appropriate time zone indication in the phonebook. This will of course not result in a correct time zone indication if the mobile communication terminal of the contact concerned is not in its home location.

FIG. 4 is a screenshot of the phonebook application with the “LOCATIONS” 37 tab active. The phonebook application 22 displays the contacts 31 accordingly in a location based fashion by showing the position of the contacts on a geographical map 40. One of the contacts 31 is active, which is indicated by a box 32 around the contact 31 concerned. With the left softkey 9 “OPTIONS” the user can access relevant contact and location based functions such as those listed for the time zone mode of the phonebook application, but also further geographical map related functions such as zooming and panning. With the navigation key 10 “SELECT” the user can initiate a new communication with the active contact, and with the rights softkey 9 “EXIT” the user can close the phonebook application to go back to the menu or to the idle mode.

FIG. 5 is a screenshot of the phonebook application with the “ABC” 37 tab active. The phonebook application 22 displays the contacts 31 accordingly in alphabetical order with one of the contacts 31 active as indicated by box 32. The local time associated with the contact 31 (as indicated by the metadata) is shown by a clock 34 next to the contact name so that a user already before initiating a new communication can determine if now is a good time to do so. The clock with the local time 34 has been shown as on analog clock with an AM or PM indication, but could alternatively be a digital clock (not shown). This applies for all analog clocks shown in this application, which could alternatively be digital clocks (not shown).

Similar to the other modes of the phonebook application 22, the user can with the softkeys 9 and the navigation key 10 access further contact related functions, initiate new communications and close the phonebook application 22.

In light of the foregoing description of the disclosed embodiments, it should be recognized that the disclosed embodiments can be realized in hardware, software, or a combination of hardware and software. The mobile communication terminal and method according to the disclosed embodiments can be realized in a centralized fashion in one computer system or processor, or in a distributed fashion where different elements are spread across several interconnected computer systems or processors (such as a microprocessor and a DSP). Any kind of mobile computer, or other apparatus adapted for carrying out the methods described herein, is suited. A typical combination of hardware and software could be a general purpose computer with a computer program that, when being loaded and executed, controls the computer system such that it carries out the methods described herein.

The disclosed embodiments can also be embedded in a computer program product, which comprises all the features enabling the implementation of the methods described herein, and which, when loaded in a computer system, is able to carry out these methods. A computer program or application in the present context means any expression, in any language, code or notation, of a set of instructions intended to cause a system having an information processing capability to perform a particular function either directly or after either or both of the following a) conversion to another language, code or notation; b) reproduction in a different material form.

The term “comprising” as used in the claims does not exclude other elements or steps. The term “a” or “an” as used in the claims does not exclude a plurality. The single processor or other unit may fulfill the functions of several means recited in the claims.

Although the disclosed embodiments have been described in detail for purpose of illustration, it is understood that such detail is solely for that purpose, and variations can be made therein by those skilled in the art without departing from the scope of the disclosed embodiments.

1. A mobile communication terminal with a phonebook function, comprising:
a processor controlling the operation of the terminal,
a memory coupled to the processor,
the memory having at least one phonebook data entry and metadata associated with the phonebook data entry,
wherein the processor is configured to sort phonebook entries by a metadata related criterion.

2. A mobile communication terminal according to claim 1, further comprising a display coupled to the processor, and the processor being configured to show the phonebook data entries on said display sorted by said metadata related criterion.

3. A mobile communication terminal according to claim 1, wherein said phonebook entry data includes phone number data, and said criterion is based on a country code in the phone number in the phonebook entry data.

4. A mobile communication terminal according to claim 1, wherein said phonebook entry data includes phone number data, and said criterion is based on an area code in the phone number in the phonebook entry data.

5. A mobile communication terminal according to claim 1, wherein said terminal is suitable for operation in a cellular network, said metadata including data on the current cell in which a terminal associated with a phonebook data entry is logged onto, and said criterion being based on the current cell data.

6. A mobile communication terminal according to claim 1, wherein said terminal is suitable for connecting to a network, and said processor is configured to receive location information concerning other terminals that are associated with one of the phonebook data entries via said network.

7. A mobile communication terminal according to claim 6, wherein said location information comprises time zone information

8. A mobile communication terminal according to claim 6, wherein said location information comprises country information.

9. A mobile communication terminal according to claim 6, wherein said location information is received via said network from a server.

10. A mobile communication terminal according to claim 1, comprising a user interface, wherein said processor is configured to add or update metadata to the memory via user input.

11. A mobile communication terminal according to claim 1, wherein said processor is configured to add or update metadata to the memory by means of data received via a network to which the mobile communication terminal is connected.

12. A mobile communication terminal according to claim 1, comprising a display coupled to the processor, wherein said processor is configured to show the sorted phonebook data entries on the display as a, preferably, scrollable list.

13. A mobile communication terminal according to claim 1, comprising a display coupled to the processor, wherein the processor is configured to show the sorted phonebook data entries on the display as a, preferably, scrollable array.

14. A mobile communication terminal according to claim 1, comprising a display coupled to the processor, wherein the processor is configured to show the sorted phonebook data entries on the display as positions on a geographical map.

15. A mobile communication terminal according to claim 1, wherein said processor is configured to extract metadata from the phonebook data entries.

16. A mobile communication terminal according to claim 1, wherein said processor is configured to sort said phonebook entries by a criterion that is related to dynamic metadata.

17. A mobile communication terminal according to claim 16, wherein said criterion is a time zone associated with a phonebook entry.

18. A mobile communication terminal with a phonebook function, comprising:
a processor controlling the operation of the terminal,
a display coupled to the processor,
a memory coupled to the processor,
the memory having at least one phonebook data entry and time zone information associated with the phonebook data entry,
wherein the processor is configured to show the phonebook data entry on the display together with information about the time zone associated with the phonebook entry.

19. A mobile communication terminal according to claim 18, wherein the processor is configured to show a plurality of phonebook entries as a list or array with the time zone information adjacent to phonebook entry concerned.

20. A mobile communication terminal according to claim 18, wherein the processor is configured to show time zone information as a local clock.

21. A mobile communication terminal according to claim 18, wherein the processor is configured to show time zone information as the difference in number of hours with GMT.

22. A method for handling phonebook entries in a phonebook on a mobile communication terminal comprising:
storing a plurality of phonebook entries in the phonebook,
assigning metadata to the phonebook entries, and
sorting said phonebook entries by a criterion related to said metadata.

23. A method according to claim 22, further comprising extracting metadata from the phonebook entries stored in the phone.

24. A method according to claim 22, further comprising showing the phonebook data entries on a display of the terminal sorted by said metadata related criterion.

25. A method according to claim 22, wherein said phonebook entry data includes phone number data, and said criterion is based on a country code in the phone number in the phonebook entry data.

26. A method according to claim 22, wherein said phonebook entry data includes phone number data, and said criterion is based on an area code in the phone number in the phonebook entry data.

27. A method according to 22, wherein said metadata includes data on the current cell in which a terminal associated with a phonebook data entry is logged onto, and said criterion being based on the current cell data.

28. A method according to claim 22, further comprising receiving dynamic metadata associated with phonebook data entries via said network.

29. A method according to claim 28, wherein said dynamic metadata comprises time zone information

30. A method according to claim 28, wherein said dynamic metadata comprises country information.

31. A method according to claim 27, wherein said dynamic metadata is received via said network from a server.

32. A method according to claim 22, further comprising adding or updating dynamic and/or fixed metadata to the terminal via user input.

33. A method according to claim 22, further comprising adding or updating dynamic and/or fixed metadata to the terminal by means of data received via a network to which the mobile communication terminal is connected.

34. A method according to claim 33, further comprising showing the sorted phonebook data entries on a display of the terminal as a list or an array.

35. A method according to claim 22, further comprising showing the sorted phonebook data entries on the display as positions on a geographical map.

36. A software product for executing the methods according to claim 22, when run on a processor of a mobile communication terminal.

37. A software product for use in a mobile communication terminal that is provided with a phonebook, said software product comprising:
software code for storing phonebook entries in the phonebook,
software code to assigning metadata to the phonebook entries, and
software code to sort said phonebook entries by a criterion related to said metadata.

38. A software product according to claim 37, further comprising software code for extracting metadata from the phonebook entries stored in the phone.

39. A software product according to claim 37, further comprising software code for showing the phonebook data entries on a display of the terminal sorted by said metadata related criterion.

40. A software product according to claim 37, further comprising software code for handling dynamic metadata related to phonebook data entries that are received by the terminal from a network.

41. A method for handling phonebook entries in a phonebook on a mobile communication terminal comprising:
storing phonebook entries in a memory of the terminal,
associating time zone data with the phonebook entries, and
showing phonebook entries on a display of the terminal together with information about the time zone associated with the phonebook entries.

42. A software product for use in a mobile communication terminal that is provided with a phonebook, said software product comprising:
software code for storing phonebook entries in a memory of the terminal, and
software code for associating time zone data with the phonebook entries,
software code for showing phonebook entries on a display of the terminal together with information about the time zone associated with the phonebook entries.
